(19) United States
(12) Patent Application Publication
(10) Pub. No.: US 2014/0268735 A1
(43) Pub. Date: Sep. 18, 2014

(54) LIGHTING DEVICE

(71) Applicant: Sharp Kabushiki Kaisha, Osaka-shi, Osaka (JP)

(72) Inventor: Masanori Watanabe, Osaka-shi (JP)

(73) Assignee: Sharp Kabushiki Kaisha, Osaka-shi, Osaka (JP)

(21) Appl. No.: 14/350,556

(22) PCT Filed: Oct. 2, 2012
(86) PCT No.: PCT/JP2012/075487

§ 371 Date: Apr. 8, 2014

(30) Foreign Application Priority Data
Oct. 14, 2011 (JP) 2011-226594

(51) Int. Cl. F21V 11/16

(52) U.S. Cl. CPC F21V 11/16
USPC 362/231; 362/235

(57) ABSTRACT

Provided is a lighting device capable of reducing an impact on the surrounding area. A lighting device capable of projecting light onto a first projection region and a second projection region which differs from the first projection region, wherein: a first light-emitting element is capable of emitting a flashing light that illuminates the first projection region; a light-blocking part blocks the light emitted by the first light-emitting element that is projected toward a region other than the first projection region; and a first optical path conversion member uses light emitted by the first light-emitting element, and converts the optical path of light emitted by the first light-emitting element in a manner such that the second projection region is illuminated by light perceived to have a smaller brightness/dimness intensity level than the flashing light from the first light-emitting element.

### CROSS-REFERENCE TO RELATED APPLICATIONS

This application is a national phase filing under 35 U.S.C. §371 of International Application No. PCT/JP2012/075487, filed on Oct. 2, 2012, and which claims priority to Japanese Patent Application No. 2011-226594, filed on Oct. 14, 2011, the contents of which prior applications are incorporated herein by reference.

### FIELD OF THE INVENTION

The present invention relates to a lighting device, for example, a lighting device that performs a flashing operation for the purpose of insect proofness in cultivation of plants or the like.

### BACKGROUND OF THE INVENTION

Since the larvae of noctuid moths such as Helicoverpa armigera and Spodoptera litura give damage to flower and ornamental plants, control of noctuid moths is important. However, many of noctuid moths have acquired drug resistance against various kinds of insecticides. Therefore, it has become difficult to perform the control by insecticides. As a method for controlling noctuid moths, in addition to insecticides, there is night lighting by a moth-proof yellow lighting device which applies light having an oviposition-inhibiting effect to imagines flying to a field for oviposition. A moth-proof yellow lighting device has been widely used since there is no adverse effect caused by fluorescent light in growth and flowering, especially, in carnation and rose.

As a moth-proof yellow lighting device, for example, there are a lighting device that uses a yellow fluorescent lamp which emits yellow light having a peak wavelength of 560 nm to 580 nm (see Patent Literature 1) and a lighting device that uses a yellow light emitting diode (yellow LED) (see Patent Literature 2, for example).

Further, in a moth-proof yellow lighting device, a configuration for allowing light to be applied to flash is disclosed as a technique for improving a moth-proof effect (see Patent Literature 3, for example). As a flashing method in a moth-proof yellow lighting device, for example, a configuration that satisfies duty ratio=light period width/(light period width+dark period width)=50% or less is described (see Patent Literature 4).

As other background art relating to the present invention, a downlight type LED lighting device which is used by being embedded in a ceiling or the like is described in Patent Literature 5. In Patent Literature 6, there is described a pseudo-rotation warning lamp which does not require a rotation driving mechanism since the pseudo-rotation warning lamp is provided with a plurality of LED light sources and a light source circuit, and the light source circuit sequentially controls current flowing to the respective LED light sources. In Patent Literature 7, there is described a surface-mounted LED in which a lens having a mortar-shaped recess and an LED chip are integrated so as to have wide light distribution characteristics. In Patent Literature 8, there is described an LED light bulb that is provided with a single LED module and a lens having a recess, and has a wide light distribution range.

### PATENT LITERATURE

Patent Literature 1: Japanese Unexamined Patent Application Publication No. 2008-154541
Patent Literature 2: Japanese Unexamined Patent Application Publication No. 2003-274839
Patent Literature 3: Japanese Unexamined Patent Application Publication No. 2003-284482
Patent Literature 4: Japanese Unexamined Patent Application Publication No. 2010-068754
Patent Literature 5: Japanese Unexamined Patent Application Publication No. 2009-64636
Patent Literature 6: Japanese Unexamined Patent Application Publication No. 2011-003440
Patent Literature 7: Japanese Unexamined Patent Application Publication No. 2002-344027
Patent Literature 8: Japanese Unexamined Patent Application Publication No. 2011-142060

### SUMMARY OF THE INVENTION

As described above, in a moth-proof yellow lighting device, it is desired to allow light to be applied to flash in order to improve a moth-proof effect. However, when light to be applied is allowed to flash, flashing light has a predisposition to attract the attention of people outside the field (neighborhood) and irritate them. Therefore, flashing light may disadvantageously give a feeling of discomfort to the neighborhood living near the field.

Further, also in a street light which emits not flashing light, but continuous light, a lighting device such as a light source for flowering adjustment of agricultural shot-day plants, and a lighting device that has a spectrum suitable for a specific purpose such as red and blue, the color or the spectrum of light emitted from the light source may disadvantageously give a feeling of discomfort or adverse effect to the neighborhood living near the field. Further, also in a lighting device such as a street light which emits not flashing light, but continuous light, when using light with a color component having large light scattering, visibility from a distant place is deteriorated, for example, stars in the night sky becomes difficult to see. Also in such a case, it is desired to further improve the visibility.

The present invention has been made in view of the above problems, and an object thereof is to provide a lighting device that can reduce the influence on the surrounding area caused by illumination which may give a feeling of discomfort or adverse effect by flashing or the like.

In a first aspect, in order to achieve the above object, a lighting device according to the present invention includes at least one first light emitting element; a light blocking unit; and a first light path conversion member, and is capable of applying light to a first illumination region and a second illumination region different from the first illumination region, wherein the first light emitting element is capable of emitting flashing light illuminating the first illumination region, the light blocking unit blocks light that is emitted from the first light emitting element and directed to a region other than the first illumination region, and the first light path conversion member converts an optical path of light emitted from the first light emitting element so that the second illumination region is illuminated with light that is perceived to have a smaller light-dark intensity difference than flashing light from the first light emitting element using light emitted from the first light emitting element.

In a second aspect, in order to achieve the above object, a lighting device according to the present invention includes at least one first light emitting element; at least one second light emitting element; and a light blocking unit, and is capable of applying light to a first illumination region and a second illumination region different from the first illumination region, wherein the first light emitting element is capable of emitting flashing light that reaches the first illumination region, the light blocking unit blocks light that is emitted from the first light emitting element and directed to a region other than the first illumination region, and the second illumination region is illuminated with light that is perceived to have a smaller light-dark intensity difference than flashing light from the first light emitting element using at least a part of light emitted from the second light emitting element.

More preferably, in the lighting device of any of the above aspects, light illuminating the second illumination region is light that is perceived as continuous light by a person at the second illumination region.

More preferably, the lighting device of any of the above aspects includes a first optical path conversion member converting the optical path of light entering the first optical path conversion member so as to illuminate the second illumination region, wherein the first optical path conversion member is provided outside an internal space surrounded by the light blocking unit.

More preferably, in the lighting device of any of the above aspects, comprising a plurality of first light emitting elements, wherein each of all-dark periods in which all of the first light emitting elements are in a dark state is set shorter than time perceivable by a human being.

More preferably, in the lighting device of any of the above aspects, comprising a plurality of first light emitting elements, wherein a light-dark pattern defined by the position of a first light emitting element in a light state and the position of a first light emitting element in a dark state rotates with the lapse of time.

More preferably, in the lighting device of any of the above aspects, the light blocking unit includes a side light blocking unit blocking light that is directed to the second illumination region from the first light emitting element without conversion of the optical path thereof, and an upper light blocking unit covering the upper part of the side light blocking unit.

More preferably, in the lighting device of any of the above aspects, the first light emitting element comprises a plurality of first light emitting elements, and a first light-dark pattern defined by the position of a first light emitting element in a light state and the position of a first light emitting element in a dark state and a second light-dark pattern which is a reverse pattern of the first light-dark pattern are temporally alternately set.

More preferably, in the lighting device of any of the above aspects, the second light emitting element emits continuous light.

More preferably, in the lighting device of the above second aspect, the second light emitting element is a phosphor emitting visible light, and further, the second light emitting element is a phosphor emitting light by being excited by light emitted from the first light emitting element.

More preferably, in the lighting device of the above second aspect, the second light emitting element emits light so that the intensity of the entire light that is directly or indirectly applied to the second illumination region falls within a predetermined light intensity range when viewed from a person at the second illumination region depending on the emission intensity of the first light emitting element viewed from a person at the second illumination region.

More preferably, the lighting device of any of the above aspects includes a second optical path conversion member bending an optical axis of the first light emitting element toward the first illumination region.

More preferably, the lighting device of any of the above aspects includes a central axis, wherein the first illumination region includes a region below the central axis, and the second illumination region includes a direction perpendicular to the central axis of the lighting device.

More preferably, in the lighting device of any of the above aspects, a direction of light that is emitted from the first light emitting element and passes through the boundary between the first illumination region and an external region is defined as an outer boundary direction, and an angle of the outer boundary direction with respect to the central axis of the lighting device is 45° or more and 85° or less.

More preferably, in the lighting device of any of the above aspects, a direction of light that is emitted from the first light emitting element and passes through the boundary between the first illumination region and an external region is defined as an outer boundary direction, a direction of light that is emitted from the first light emitting element and has a maximum intensity is defined as a reference direction, and an angle of the reference direction with respect to the outer boundary direction is set to the range from 20° inside with respect to the first illumination region to 30° outside with respect to the first illumination region.

More preferably, in the lighting device of any of the above aspects, the first light emitting element emits yellow component light having a peak wavelength of 540 nm or more and 620 nm or less, and does not emit blue component light having a wavelength of 400 to 500 nm or emits light having an intensity that does not allow blue component light having a wavelength of 400 to 500 nm to have an insect attracting action.

More preferably, in the lighting device of any of the above aspects, each of a light period and a dark period of the flashing light is 10 ms or more and 1000 ms or less.

In a third aspect, in order to achieve the above object, a lighting device according to the present invention includes at least one first light emitting element; at least one second light emitting element; and a light blocking unit, and is capable of applying light to a first illumination region and a second illumination region different from the first illumination region, wherein the first light emitting element is capable of emitting main light illuminating the first illumination region, the second light emitting element is capable of emitting auxiliary light having a spectrum different from the spectrum of the main light, the auxiliary light illuminating the second illumination region, the light blocking unit blocks light that is emitted from the first light emitting element and directed to a region other than the first illumination region, light emitted from the second light emitting element is applied to the second illumination region, and the second illumination region includes a direction perpendicular to an axis of the lighting device.

With the lighting device of the first aspect, flashing light as main light is applied only to the first illumination region, and light as auxiliary light that is perceived to have a smaller light-dark intensity difference than flashing light (continuous light, for example) is applied to the second illumination region in which a person is present. Therefore, light from the lighting device of the above aspect is recognized as light having a smaller light-dark intensity difference than flashing light by a person at the second illumination region. Therefore, it is possible to reduce a feeling of discomfort to the person caused by flashing light while maintaining a moth-proof effect by the flashing light. Further, even if reflected or scattered flashing light reaches a person at the second illumination region, the person at the second illumination region mainly observes light having a smaller light-dark intensity difference than the flashing light that has reached the second illumination region (continuous light, for example). Therefore, it is possible to reduce a feeling of discomfort to the person compared to the case with only flashing light.

With the lighting device of the second aspect, flashing light as main light is applied only to the first illumination region, and light as auxiliary light that is perceived to have a smaller light-dark intensity difference than flashing light (continuous light, for example) is applied to the second illumination region in which a person is present. Therefore, light from the lighting device of the above aspect is recognized as light having a smaller light-dark intensity difference than flashing light by a person at the second illumination region. Therefore, it is possible to reduce a feeling of discomfort to the person caused by flashing light while maintaining a moth-proof effect by the flashing light. Further, even if reflected or scattered flashing light reaches a person at the second illumination region, the person at the second illumination region mainly observes light having a smaller light-dark intensity difference than the flashing light that has reached the second illumination region (continuous light, for example). Therefore, it is possible to reduce a feeling of discomfort to the person compared to the case with only flashing light.

With the lighting device of the third aspect, main light is applied only to the first illumination region, and auxiliary light is applied to the second illumination region in which a person is present. For example, by making the auxiliary light have preferred characteristics (spectrum) for a person at a distance place compared to the main light, it is possible to reduce the influence of the main light on the person at a distant place.

### BRIEF DESCRIPTION OF THE DRAWINGS

FIGS. 1A to 1C are a schematic external view, a schematic cross-sectional view, and a schematic bottom view illustrating an example of the schematic configuration in a first embodiment of a lighting device according to the present invention.

FIG. 2 is a graph illustrating the spectrum of a first light emitting element which constitutes the lighting device according to the present invention.

FIG. 3 is a schematic diagram illustrating the positional relationship between the lighting device and a person in the first embodiment of the lighting device according to the present invention.

FIG. 4 is a schematic diagram illustrating the change with time of partial illumination regions in a first illumination region in the first embodiment of the lighting device according to the present invention.

FIG. 5 is a graph illustrating the change with time of light-dark in the first embodiment of the lighting device according to the present invention.

FIG. 6 is a schematic cross-sectional view illustrating an example of the schematic configuration in a second embodiment of the lighting device according to the present invention.

FIG. 7 is a schematic cross-sectional view illustrating an example of the schematic configuration in a third embodiment of the lighting device according to the present invention.

FIG. 8 is a schematic cross-sectional view illustrating an example of the schematic configuration in a fourth embodiment of the lighting device according to the present invention.

FIGS. 9A and 9B are a schematic cross-sectional view and a bottom view illustrating an example of the schematic configuration in a fifth embodiment of the lighting device according to the present invention.

FIGS. 10A and 10B are graphs illustrating the change with time of light emission of a first light emitting element and a second light emitting element in the lighting device according to the present invention.

FIGS. 11A and 11B are a schematic perspective view and a schematic bottom view (the configuration inside an internal space excepting a window and a light scattering member) illustrating an example of the schematic configuration in a sixth embodiment of the lighting device according to the present invention.

FIGS. 12A to 12C are schematic diagrams illustrating the change with time of partial illumination regions in a first illumination region in the sixth embodiment of the lighting device according to the present invention.

FIG. 13 is a schematic cross-sectional view illustrating the arrangement of first light emitting elements in another embodiment of the lighting device according to the present invention.

FIGS. 14A to 14E are graphs illustrating the change with time of a light-dark pattern in another embodiment of the lighting device according to the present invention.

FIGS. 15A and 15B are schematic partial cross-sectional views illustrating the configuration of a window in another embodiment of the lighting device according to the present invention.

FIGS. 16A and 16B are a schematic cross-sectional view and a bottom view illustrating an example of the schematic configuration in an eighth embodiment of the lighting device according to the present invention.

FIGS. 17A and 17B are a schematic cross-sectional view and a bottom view illustrating an example of the schematic configuration in a ninth embodiment of the lighting device according to the present invention.

FIGS. 18A and 18B are a schematic cross-sectional view and a bottom view illustrating an example of the schematic configuration in a tenth embodiment of the lighting device according to the present invention.

### DETAILED DESCRIPTION OF THE INVENTION

Hereinbelow, embodiments of a lighting device according to the present invention will be described on the basis of the drawings.

The first embodiment of the lighting device according to the present invention will be described on the basis of FIGS. 1A to 5. In the present embodiment, a moth-proof lighting device that is used for the purpose of preventing insects such as noctuid moths which give damage to flower and ornamental plants is assumed as a lighting device 1A.

First, the configuration of the lighting device 1A will be described on the basis of FIGS. 1A to 3.

In FIGS. 1A to 1C, for the purpose of explanation, the lighting device 1A has an axisymmetric shape. Further, an X axis is set in the direction of a central axis α of the lighting device 1A, and a Y axis and a Z axis are set in the direction perpendicular thereto. The Y axis and the Z axis are perpendicular to each other. Although a description will be made assuming the central axis α as the direction of gravity for the purpose of explanation, the present invention is not limited thereto. Further, the shape of the lighting device 1A is not necessarily an axisymmetric shape. FIG. 1A is a schematic external view illustrating the external appearance of the lighting device 1A; FIG. 1B is a schematic cross-sectional view illustrating a cross section including the central axis α of the lighting device 1A; and FIG. 1C is a schematic bottom view viewed from a lower direction of the central axis α of the lighting device 1A.

The lighting device 1A is provided with LEDs as a plurality of first light emitting elements 11. The lighting device 1A can apply main light which is flashing light to a first illumination region which includes a downwardly extended part of the central axis α, and can apply auxiliary light which can be recognized as continuous light by a human being to a second illumination region which is different from the first illumination region and includes the direction perpendicular to the central axis α from the lighting device 1A.

More specifically, as illustrated in FIGS. 1A to 1C, the lighting device 1A is an LED bulb type lighting device. The lighting device 1A is provided with a plug 3, an outer wall member 2, a drive circuit 4 which is arranged inside the outer wall member 2, the plurality of first light emitting elements 11 which can emit flashing light, a light blocking unit 12 which blocks flashing light that is emitted from the first light emitting elements 11 and directly heads for the second illumination region from the lighting device 1A without passing through a first optical path conversion member, and a light scattering unit 17 as the first optical path conversion member which converts the optical path of a part of light emitted from the first light emitting elements 11. The lighting device 1A applies auxiliary light which is perceived as continuous light by a person at the second illumination region to the second illumination region from the first light emitting elements 11 through the light scattering unit 17. A target for light blocking by the light blocking unit 12 is light that directly heads for a region other than the first illumination region from the lighting device 1A, and light reflected by plants or the like is exempt from the light blocking.

In the present embodiment, the first illumination region is set to a target area for insect proofness, for example, a cultivation area of carnation or rose at the time of use (in this case, the same as the time of installation). In this specification, it is assumed that a plurality of lighting devices 1A are used for a single cultivation area. The first illumination regions of the lighting devices 1A are set so that the entire cultivation area corresponds to any of the first illumination regions of the lighting devices 1A.

The second illumination region is set so as to include the direction perpendicular to the central axis of the lighting device, and corresponds to a direction in which people of the neighborhood are present when normally using the lighting device 1A.

The plug 3 is connected to a commercial AC power source (AC100 V to 230 V, 50 Hz or 60 Hz), and supplies power to the drive circuit 4. The plug 3 may have a configuration that can be connected to a DC power source or a pulsed power source. In this case, a power circuit 4b inside the drive circuit 4 may not be provided.

As illustrated in FIG. 1A, the outer wall member 2 includes a tubular member which expands downward so as to be axisymmetric to the central axis α. The tubular member is composed of a material having a function to dissipate heat generated from the first light emitting elements 11. The plug 3 is provided on the upper end of the tubular member, and the drive circuit 4 is provided inside an internal space of the central part of the tubular member. The external dimension of the lower end of the tubular member which constitutes the outer wall member 2 (“L”) is, for example, 58 mm. The shape of the outer wall member 2 may not be a tubular shape, and may be the side face of a rectangular column or a frustum, or other shapes. Hereinbelow, in the present embodiment, a description will be made assuming the case where the lighting device 1A is installed so that the central axis α is parallel to the vertical direction (the direction of gravity) at the time of use. However, the central axis α is not necessarily parallel to the vertical direction, and the installation position or angle may differ between the time of use and the time of non-use.

The drive circuit 4 includes a flashing circuit 4a which controls a flashing operation of the first light emitting elements 11 and the power circuit 4b which supplies a predetermined power to the first light emitting elements 11. The flashing circuit 4a and the power circuit 4b are not necessarily provided on the same circuit board as the drive circuit 4. The flashing circuit 4a and the power circuit 4b may be individually provided on different circuit boards, or only the flashing circuit 4a or a part of the drive circuit 4 may be provided on the inner side of the outer wall member 2.

In order to apply main light to the first illumination region, in the present embodiment, eight first light emitting elements 11a to 11h, a printed circuit board 15 on which the light emitting elements 11 are mounted, and the light blocking unit 12 are provided.

More specifically, as illustrated in FIG. 1B, the light blocking unit 12 includes a side light blocking unit 13 which is formed of the side face of a truncated cone and an upper light blocking unit 14 which is formed of the top face of the truncated cone. The side light blocking unit 13 restricts the direction of flashing light emitted from the first light emitting elements 11 so as not to directly reach a person at a distant place from the lighting device 1A, and has a function to block main light (flashing light) so as not to be directed at least to the direction perpendicular to the central axis α. The inner side of the light blocking unit 12 is formed into a mirror surface or a white reflection surface. In order to reduce unnecessary reflected light or scattered light, a part or the entire of the inner side of the light blocking unit 12 may have a configuration that prevents the generation of reflected light and scattered light such as a black surface. Further, the light blocking unit 32 is placed adjacent to an opening of the outer wall member 2 so that the central axis of the light blocking unit 12 overlaps with the central axis α of the outer wall member 2, the upper light blocking unit 14 is located on the side facing the drive circuit 4, and an opening of the light blocking unit 12 is located on the opposite side of the drive circuit 4.

The printed circuit board 15 is a flexible circuit board, and is provided in the side light blocking unit 13 along the edge thereof inside an internal space having a truncated cone shape surrounded by the light blocking unit 12.

The first light emitting elements 11 are annularly arranged at equal intervals on the flexible circuit board.

In the present embodiment, each of the first light emitting elements 11 is a surface-mounted LED which has an excellent heat dissipation property and is suitable for illumination requiring high luminance, is constituted using a blue LED element and a yellow phosphor, and emits light having a color coordinate of (0.42, 0.48). FIG. 2 illustrates the spectrum of each of the first light emitting elements 11 in the present embodiment. As illustrated in FIG. 2, the peak wavelength of the first light emitting elements 11 is set to 565 nm. Further, blue components having a wavelength of 400 to 500 nm which attract insects such as a moth are reduced. Further, yellow components having a wavelength of 565 nm to 590 nm which are avoided by insects such as a moth and suppress the action (copulation) of insects are increased. Therefore, it is possible to obtain a high moth-proof effect. Containing less blue components means that the emission intensity of the blue components is small enough to be able to ignore an insect attracting action.

In the present embodiment, the case where the peak wavelength is set to 565 nm has been described. However, the peak wavelength is preferably 540 nm or more and 620 nm or less, and more preferably 565 nm or more and 590 nm or less. Further, a normal white LED or bulb color LED and a filter through which a blue component which attracts insects is not transmitted or hardly transmitted may be used so that light of a color having a moth-proof effect is applied to the first illumination region without using a yellow LED. A bulb color LED contains less blue components, and therefore does not necessarily require a filter.

In this specification, the case where a surface-mounted LED is used is described. However, a shell type LED which has a narrow half-value width of the radiation angle and strong directivity may be used. Since a shell type LED has a strong directivity, it is easy to illuminate a specific region. Therefore, the optical design of a light emission device becomes easy.

FIG. 3 illustrates the positional relationship between the lighting device 1A and partial illumination regions AS11 and AS15 and a person H at a distant place when the lighting device 1A is installed, that is, when the central axis α of the outer wall member 2 is made parallel to the vertical direction X. The partial illumination region AS11 indicates a region to which light emitted from the first light emitting element 11a is directly applied without passing through the light scattering unit 17. The partial illumination region AS15 indicates a region to which light emitted from the first light emitting element 11e is directly applied without passing through the light scattering unit 17. As illustrated in FIG. 3, the lighting device 1A is installed so that the central axis α thereof is parallel to the vertical direction X and light scattered by the light scattering unit 17 as the first optical conversion member is visually recognized by the person H at a distant place.

Hereinbelow, for the purpose of explanation, the first light emitting element 11a will be described. However, the first light emitting elements 11b to 11h have the same configuration as the first light emitting element 11a. In FIG. 3, the direction of light that is emitted from the first light emitting element 11 and passes through the boundary between the first illumination region and an external region is denoted by an outer boundary direction β, an optical axis of the first light emitting element 11 (the direction in which the intensity becomes maximum, in this case) is denoted by a reference direction γ, the angle between the central axis α and the outer boundary direction β is denoted by θ₁, and the angle between the central axis α and the reference direction γ is denoted by θ₂.

The angle θ₁ is set to an angle that does not allow the person H at a distant position that is substantially perpendicular to the central axis α of the lighting device 1A to directly visually recognize main light emitted from the first light emitting element 11 and can ensure the size of the first illumination region. In order to ensure the size of the first illumination region, θ₁ is preferably set to 45° or more. Therefore, θ₁ is preferably set to 45° or more and 85° or less. Further, θ₁ is more preferably set to 60° or more and 80° or less. In the present embodiment, θ₁ is set to 75°. The angle of θ₁ is appropriately set depending on the installation angle of the present embodiment and optical components of the first light emitting element 11 (the size of scattered light or the like).

Further, in the present embodiment, the angle (θ₂−θ₁) of the reference direction γ with respect to the outer boundary direction β is set to the range from 20° inside with respect to the first illumination region to 30° outside with respect to the first illumination region (−20° to +30°), specifically, set to θ₂−θ₁=−5°, and θ₂=70°. The angle (θ₂−θ₁) is more preferably set to −10° to +15°. By setting θ₁ and θ₂ in this manner, it is possible to suppress the intensity of light applied to a region directly below the lighting device 1A at the time of use and increase the intensity of light applied to the vicinity of the boundary between the first illumination region and the external region. Accordingly, it is possible to effectively prevent noctuid moths from entering the first illumination region. As illustrated in FIG. 3, main light from two first light emitting elements 11 is applied to the region directly below the lighting device 1A (an overlapping region between AS11 and AS15) at the time of use, and only main light from one first light emitting element 11 is applied to a region other than the region directly below the lighting device 1A. Therefore, by increasing the intensity of light applied to a region near the external region in the first illumination region, it is possible to reduce unevenness in the intensity of light applied to the first illumination region. A value of the angle (θ₂−θ₁) is appropriately set depending on the installation angle of the lighting device 1A and optical components of the first light emitting elements 11 (the size of scattered light or the like).

Light from the first light emitting elements 11 is blocked by the light blocking unit 12, and therefore cannot be directly visually recognized from the person H. However, light reflected by the ground or plants may be visually recognized. In the lighting device 1A, since the light scattering unit as the first optical path conversion member is provided, the attention of the person H at the second illumination region is more attracted to auxiliary light from the light scattering unit, and the influence of light reflected by the ground or plants is therefore reduced.

In the present embodiment, the light scattering member 17 as the first optical path conversion member which directs a part of light emitted from the first light emitting elements 11 toward the second illumination region as auxiliary light is provided. The light scattering member 17 is arranged on the center of a window 16 which is composed of a flat plate-like transparent member which covers the bottom face of the internal space of the light blocking unit 12 outside (lower side) the internal space having a truncated cone shape surrounded by the light blocking unit 12. The light blocking unit 12 is sealed by the window 16 to protect the first light emitting elements 11 from rain or the like. In the present embodiment, the window 16 is provided, and the light scattering member 17 is provided on the center of the window 16. However, the present invention is not limited thereto. The window 16 is not necessarily provided. The light scattering member 17 is only required to be provided outside the internal space, and may also be provided in a place other than the window 16.

More specifically, the light scattering member 17 scatters light entering the light scattering member 17 so as to include light having an angle in the range of 85° to 90° with respect to the central axis α. The light scattering member 17 is composed of a transparent resin, glass having a roughened surface, a white resin such as silicon-based resin and fluorine-based resin, a white sponge, or white ceramics such as alumina. Further, the light scattering member 17 is arranged at an equal distance from all of the first light emitting elements 11a to 11h. Therefore, when viewed from the person H illustrated in FIG. 3 (described below), whichever of the first light emitting elements 11a to 11h is turned on, the intensity of light emitted from the light scattering unit is substantially constant.

Next, a light applying operation in the lighting device 1A will be described on the basis of FIGS. 4 and 5.

In the following description, a dark state is not necessarily an off state in which the first light emitting elements 11 do not emit light. It is only required that there is a difference between the intensity of light in a light state and the intensity of light in a dark state.

In the present embodiment, the flashing circuit 4a of the drive circuit 4 performs driving control so that a light-dark pattern which is defined by the position of a first light emitting element 11 in a light state and the position of a first light emitting element 11 in a dark state in the plurality of first light emitting elements 11 rotates with the lapse of time (illumination by pseudo-rotating light).

More specifically, as illustrated in FIGS. 4 and 5, a light-dark pattern in which two first light emitting elements 11 that are located symmetrical to each other are in a light state and the other first light emitting elements 11 are in a dark state rotates in the clockwise direction in FIG. 1C. The rotation direction may be an opposite direction. By allowing the two first light emitting elements 11 located symmetrical to each other to become a light state at the same time, it is possible to suppress the influence of a shadow in the light scattering member 17 and further suppress flickering of light reflected and scattered from the first illumination region.

In FIG. 5, an interval Tb for switching change with time of a light-dark pattern is set to 20 ms. Since eight first light emitting elements 11 are provided in the present embodiment, each of the first light emitting elements 11 becomes a light state at every 80 ms (a flashing period is 80 ms). The interval Tb is 2 ms or more and 4000 ms or less in the present embodiment in view of a moth-proof effect. However, the interval Tb is more preferably 8 ms or more and 2000 ms or less, further more preferably 15 ms or more and 1000 ms or less, and most preferably 30 ms or more and 200 ms or less.

As illustrated in FIG. 5, from time T1 to time T2, the first light emitting element 11a and the first light emitting element 11e are in a light state, and, as illustrated in FIG. 4, flashing light is applied to the partial illumination regions AS11 and AS15. From time T2 to time T3, the first light emitting element 11b and the first light emitting element 11f are in a light state, and flashing light is applied to partial illumination regions AS12 and AS16. Similarly, from time T3 to time T4, the first light emitting element 11c and the first light emitting element 11g are in a light state, and flashing light is applied to partial illumination regions AS13 and AS17. From time T4 to time T5, the first light emitting element 11d and the first light emitting element 11h are in a light state, and flashing light is applied to partial illumination regions AS14 and AS18. With such a configuration, a partial illumination region looks like rotating in the clockwise direction on the first illumination region.

As described above, in the present embodiment, any one of the first light emitting elements 11 is always in a light state, and there is no all-dark period in which all of the first light emitting elements 11 are in a dark state (a configuration with zero all-dark period) in a use state. In the present embodiment, since a part of light emitted from the first light emitting elements 11 is scattered by the scattering member so as to be used as auxiliary light, the light scattering member 17 constantly shines. Therefore, the person H illustrated in FIG. 3 can perceive light from the light scattering member 17 as continuous light or light having a smaller light-dark intensity difference than flashing light from each of the first light emitting elements 11. The all-dark period is not necessarily zero, and when the all-dark period is set to be shorter than time that is perceivable by a human being, the person H can perceive the light as continuous light. A normal person can perceive the light as continuous light when the all-dark period is 10 ms or less. Even a considerably sensitive person can perceive the light as continuous light when the all-dark period is 5 ms or less. Therefore, when switching a light-dark pattern, an all-dark period of 5 ms or less may be generated.

Next, the installation state and light applying state of the lighting devices 1A in the entire field will be described. In the present embodiment, it is assumed that a plurality of lighting devices 1A are installed in the field.

The arrangement of the lighting devices 1A is set so that the entire field corresponds to any of the first illumination regions of the respective lighting devices 1A and the first illumination regions of the respective lighting devices 1A do not overlap with each other as far as possible since, in an overlapping region between first illumination regions, time during which light is applied thereto becomes long and a flashing effect may therefore be reduced. However, in the case where first illumination regions overlap with each other, if the state (a light state or a dark state) of first light emitting elements which apply light to the overlapping region between the first illumination regions is the same between two lighting devices 1A, a flashing effect is not reduced even when the first illumination regions overlap with each other.

Specifically, when the height of a plant is 1 m, the height of lighting devices 1A is set to 1.8 m, and a distance between adjacent two lighting devices 1A is set to 6 m so that the illuminance at the tip of the plant becomes 1 to 101 x, and the corresponding light energy density becomes 2 to 20 mW/m². In the case of an 18 m×18 m field, nine (3×3=9) lighting devices 1A are provided.

Light from the light scattering member 17 is not limited to continuous light, and is only required to be light having a smaller light-dark intensity difference perceived by a human being than flashing light from each of the first light emitting elements 11.

The second embodiment of the lighting device according to the present invention will be described on the basis of FIG. 6. In the present embodiment, as with the first embodiment, a moth-proof lighting device is assumed as the lighting device.

In the present embodiment, there will be described a case where a prism 26 as a second optical path conversion member which bends light that is emitted from a first light emitting element 21 and directed to a direction other than a first illumination region toward the first illumination region is provided compared to the lighting device 1A of the first embodiment.

In FIG. 6, for the purpose of explanation, an X axis is set in the direction of a central axis a of a lighting device 1B, and a Y axis and a Z axis are set so as to be perpendicular thereto in the same manner as in FIGS. 1A to 1C. FIG. 6 illustrates a cross section including the central axis α of the lighting device 1B in the present embodiment. Although a description will be made assuming the direction of the central axis α as the direction of gravity in the same manner as in the first embodiment, the present invention is not limited thereto.

As illustrated in FIG. 6, the lighting device 1B is an LED bulb type lighting device that is provided with a plurality of first light emitting elements 21, and can apply main light to the first illumination region which includes a downwardly extended part of the central axis α and can apply auxiliary light to a second illumination region which includes the direction perpendicular to the central axis α from the lighting device 1B through a light scattering member 17 as a first optical path conversion member. The lighting device 1B is provided with a plug 3, an outer wall member 2, and a drive circuit 4. The configurations of the plug 3, the outer wall member 2, and the drive circuit 4 are the same as those of the first embodiment. Further, the setting of the first illumination region and the second illumination region is the same as that of the first embodiment.

In order to apply main light to the first illumination region, in the present embodiment, eight first light emitting elements 21a to 21 h, a printed circuit board 25 on which the first light emitting elements 21 are mounted, prisms 25 which are provided corresponding to the respective first light emitting elements 21, and a light blocking unit 22 are provided. In the present embodiment, the first light emitting elements 21 perform the light emitting operation in the first embodiment.

More specifically, as illustrated in FIG. 6, the light blocking unit 22 includes, in an inner peripheral surface facing an internal space, a side light blocking unit 23 which is formed of the side face of a cylinder and an upper light blocking unit 24 which is formed of the top face of the cylinder. In the present embodiment, the inner side of the light blocking unit 22 has a configuration that prevents the generation of reflected light and scattered light. The inner side of the upper light blocking unit 24 may have a configuration that allows the generation of reflected light and scattered light. The light blocking unit 22 is placed adjacent to an opening of the outer wall member 2 so that the central axis of the light blocking unit 22 overlaps with the central axis α of the outer wall member 2, the upper light blocking unit 24 is located on the side facing the drive circuit 4, and an opening of the light blocking unit 22 is located on the opposite side of the drive circuit 4.

The printed circuit board 25 is a flexible circuit board, and is provided along the edge of the side light blocking unit 23 in the internal space having a cylindrical shape surrounded by the light blocking unit 22.

As with the first embodiment, the first light emitting elements 21 are surface-mounted LEDs which emit light having a spectrum illustrated in FIG. 2, and are annularly arranged at equal intervals on the flexible circuit board 25.

Further, the prisms 26 as the second optical path conversion members are provided near the respective first light emitting elements 21. The placement position and the placement angle of each of the prisms 26 are set so that light emitted from each of the first light emitting elements 21 is directed to the inside of the first illumination region by the corresponding prism 26. In the present embodiment, as illustrated in FIG. 6, an angle θ₃ between an optical axis c of light after reaching the prism 26 and the central axis α is set to, for example, 70°. The angle θ₃ is set to 45° or more and 85° or less which does not allow a person to visually recognize the first light emitting elements 21 and can ensure the size of the first illumination region.

In the present embodiment, the case where the prisms 26 are individually provided for the respective first light emitting elements 21 has been described. However, the present embodiment is not limited thereto. For example, a single prism 26 having a doughnut shape is provided in common for all of the first light emitting elements 21. Further, the prisms 26 are provided so as to be supported by the light blocking unit 22 in the present embodiment. However, the prisms 26 may be arranged on a window 16.

In order to apply auxiliary light to the second illumination region, the lighting device 1B is provided with the light scattering member 17 which scatters a part of light emitted from the first light emitting elements 21 toward the second illumination region in the same manner as in the first embodiment. The light scattering member 17 as the first optical path conversion member is arranged on the center of the window 16 which is composed of a flat plate-like transparent member which covers the bottom face of the internal space of the light blocking unit 12 outside (lower side) the internal space having a truncated cone shape surrounded by the light blocking unit 12. The light blocking unit 22 is sealed by the window 16 to protect the first light emitting elements 21 from rain or the like. In the present embodiment, the window 16 is provided, and the light scattering member 17 is provided on the center of the window 16. However, the present invention is not limited thereto. The window 16 is not necessarily provided. The light scattering member 17 is only required to be provided outside the internal space, and may also be provided in a place other than the window 16.

Further, in the present embodiment, it is assumed that each of the first light emitting elements 21 is an upper surface emission type light emitting element which emits light in the direction perpendicular to a surface on which the first light emitting element is placed. However, a side emission type light emitting element which emits light in the direction of the surface on which the first light emitting element is placed may be used. When using a side emission type light emitting element, the first light emitting elements 21 can be placed not on the side light blocking unit 23, but on the upper light blocking unit 24 as in the third embodiment described below.

The third embodiment of the lighting device according to the present embodiment will be described on the basis of FIG. 7. In the present embodiment, as with the first and second embodiments, a moth-proof lighting device is assumed as the lighting device.

In the present embodiment, there will be described a case where first light emitting elements 31 are provided not in a side light blocking unit 33, but in an upper light blocking unit 34 compared to the lighting device 1A of the first embodiment.

In FIG. 7, for the purpose of explanation, an X axis is set in the direction of a central axis α of a lighting device 1C, and a Y axis and a Z axis are set in the direction perpendicular thereto in the same manner as in FIGS. 1A to 1C. FIG. 7 illustrates a cross section including the central axis α of the lighting device 1C in the present embodiment. Although a description will be made assuming the direction of the central axis α as the direction of gravity in the same manner as in the first embodiment, the present invention is not limited thereto.

As illustrated in FIG. 7, the lighting device 1C is an LED bulb type lighting device that is provided with the plurality of first light emitting elements 31, and can apply main light to a first illumination region which includes a region below the central axis α and auxiliary light to a second illumination region which includes the direction perpendicular to the central axis α. The lighting device 1C is provided with a plug 3, an outer wall member 2, a drive circuit 4, and a light scattering unit 38 as a first optical path conversion member. The configurations of the plug 3, the outer wall member 2, and the drive circuit 4 are the same as those of the first and second embodiments. Further, the setting of the first illumination region and the second illumination region is also the same as that of the first embodiment.

In order to apply main light to the first illumination region, in the present embodiment, eight first light emitting elements 31a to 31h, a printed circuit board 35 on which the first light emitting elements 31 are mounted, and a light blocking unit 32 are provided. In the present embodiment, the first light emitting elements 31a to 31h perform the light applying operation in the first embodiment.

More specifically, as illustrated in FIG. 7, the light blocking unit 32 includes a side light blocking unit 33 which has an inner peripheral surface facing an internal space in which the first light emitting elements are housed, the inner peripheral surface being formed of the side face of a cylinder, and an outer peripheral surface having a truncated cone shape, and an upper light blocking unit 34 which is formed of the top face of the cylinder. The inner side of the light blocking unit 32 is formed into a white reflection surface. In order to reduce unnecessary reflected light and scattered light, a part or the entire of the inner side of the light blocking unit 32 may have a configuration that prevents the generation of reflected light and scattered light such as a black surface. Further, the light blocking unit 32 is placed adjacent to an opening of the outer wall member 2 so that the central axis of the light blocking unit 32 overlaps with the central axis α of the outer wall member 2, the upper light blocking unit 34 is located on the side facing the drive circuit 4, and an opening of the light blocking unit 32 is located on the opposite side of the drive circuit 4.

The printed circuit board 35 is a circular flat plate-like circuit board, and is provided in the upper light blocking unit 34 inside the internal space having a cylindrical shape surrounded by the light blocking unit 32.

The first light emitting elements 31 are surface-mounted LEDs which emit light having a spectrum illustrated in FIG. 2, and are annularly arranged at equal intervals on the circular printed circuit board 35.

In the present embodiment, each of the first light emitting elements 31 is provided with a lens 36 the central part of which is recessed compared to the outer peripheral part thereof. In the present embodiment, the first light emitting elements 31 are arranged on the printed circuit board 35 which is placed in the upper light blocking unit 34. A central axis direction 6 of each of the first light emitting elements 31 is parallel to the central axis α of the lighting device 1C. Further, in each of the first light emitting elements 31, a direction γ of light having a maximum intensity is inclined by approximately 65° with respect to the central axis direction δ (θ₄=65°). With such a configuration, even when the first light emitting elements 31 are arranged on the flat plate-like printed circuit board 35, it is possible to increase the intensity of light applied to a region near an external region in the first illumination region, and thereby reduce unevenness in the intensity of light applied to the first illumination region.

Further, as with the first embodiment, when the direction of light that is emitted from the first light emitting elements 31 and passes through the boundary between the first illumination region and the external region is denoted by an outer boundary direction β and the angle between the central axis α and the outer boundary direction β is denoted by θ₁, θ₁ is set to 75°.

In order to apply auxiliary light to the second illumination region, in the present embodiment, the light scattering member 38 as the first optical path conversion member which scatters a part of light emitted from the first light emitting elements 31 toward the second illumination region is provided. The light scattering member 38 is integrally formed with the center of the window 37 which is composed of a transparent member which covers the bottom face of the internal space of the light blocking unit 32. The light blocking unit 32 is sealed by the window 37 to protect the first light emitting elements from rain or the like. In the present embodiment, the window 37 is provided, and the light scattering member 38 is integrally provided with the center of the window 37. However, the present invention is not limited thereto. The window 37 is not necessarily provided. The light scattering member 38 may be independently provided.

As illustrated in FIG. 7, the window 37 of the present embodiment has a shape whose central part is curved outward. Accordingly, the light scattering member 38 is integrally formed with the window 37 outside the internal space of the light blocking unit 32.

In the present embodiment, for the purpose of explanation, the central axis direction 8 of each of the first light emitting elements 31 is parallel to the central axis cc. However, an inclination of 20° or less may be provided. In this case, it is possible to support adjustment of the angle of light from the first light emitting elements 31. Further, the central axis direction 8 may have an inclination of 10° or less with respect to the central axis α.

The fourth embodiment of the lighting device according to the present embodiment will be described on the basis of FIG. 8. In the present embodiment, as with the first and second embodiments, a moth-proof lighting device is assumed as the lighting device.

In the present embodiment, there will be described a case where first light emitting elements 41 each of which is not provided with the lens 36 are used compared to the lighting device 1C of the third embodiment.

In FIG. 8, for the purpose of explanation, an X axis is set in the direction of a central axis a of a lighting device 1D, and a Y axis and a Z axis are set in the direction perpendicular thereto in the same manner as in FIGS. 1A to 1C. FIG. 8 illustrates a cross-sectional view including the central axis α of the lighting device 1D in the present embodiment. Although a description will be made assuming the direction of the central axis α as the direction of gravity in the same manner as in the first embodiment, the present invention is not limited thereto.

As illustrated in FIG. 8, the lighting device 1D is an LED bulb type lighting device that is provided with the plurality of first light emitting elements 41, and can apply main light to a first illumination region and auxiliary light to a second illumination region. The lighting device 1D is provided with a plug 3, an outer wall member 2, a drive circuit 4, and a light scattering unit 17 as a first optical path conversion member. The configurations of the plug 3, the outer wall member 2, and the drive circuit 4 are the same as those of the first and second embodiments. Further, the setting of the first illumination region and the second illumination region is also the same as that of the first embodiment.

In order to apply main light to the first illumination region, in the present embodiment, eight first light emitting elements 41a to 41 h as the plurality of first light emitting elements 41, a printed circuit board 45 on which the first light emitting elements 41 are mounted, and a light blocking unit 42 are provided. In the present embodiment, the first light emitting elements 41a to 41h perform the light applying operation in the first embodiment.

More specifically, the printed circuit board 45 of the present embodiment is a flat plate-like printed circuit board having a hole on a central part thereof, and is provided in an upper light blocking unit 44 inside an internal space having a truncated cone shape surrounded by the light blocking unit 42 having a cylindrical outer circumferential shape.

The first light emitting elements 41 are surface-mounted LEDs which emit light having a spectrum illustrated in FIG. 2, and are annularly arranged at equal intervals on the circular printed circuit board 45.

As illustrated in FIG. 8, the light blocking unit 42 includes a side light blocking unit 43 whose inner side is formed of the side face of a truncated cone and outer side is formed of the side face of a cylinder and the upper light blocking unit 44 which is formed of the top face of the truncated cone-like inner side. In the present embodiment, the cross-sectional shape of the internal space is a circular shape whose area expands toward the upper side of the central axis α, and the top face having a largest area is defined as the upper light blocking unit 44. The inner side of the light blocking unit 42 is formed into a white reflection surface. In order to reduce unnecessary reflected light and scattered light, a part of the inner side of the light blocking unit 42 may have a configuration that prevents the generation of reflected light and scattered light such as a black surface. Further, the light blocking unit 42 is placed adjacent to an opening of the outer wall member 2 so that the central axis of the light blocking unit 42 overlaps with the central axis α of the outer wall member 2, the upper light blocking unit 44 is located on the side facing the drive circuit 4, and an opening of the light blocking unit 42 is located on the opposite side of the drive circuit 4.

In FIG. 8, the angle between the direction of light from the first light emitting elements 41 after being reflected by the side light blocking unit 43 and the central axis α is denoted by θ₅, and the angle θ₅ is set to 45° or more and 85° or less.

In order to apply auxiliary light to the second illumination region, in the same manner as in the first embodiment, the light scattering member 17 as the first optical path conversion member which scatters a part of light emitted from the first light emitting elements 41 toward the second illumination region is provided. The light scattering member 17 is integrally formed with the center of a window 16 which is composed of a transparent member which covers the bottom face of the internal space of the light blocking unit 42. The internal space surrounded by the light blocking unit 42 is sealed by the window 16 to protect the first light emitting elements from rain or the like. In the present embodiment, the window 16 is provided, and the light scattering member 17 is integrally provided with the center of the window 16. However, the present invention is not limited thereto. The window 16 is not necessarily provided. The light scattering member 17 may be independently provided.

In the present embodiment, light from the first light emitting elements 41 is reflected by the side light blocking unit 43 to thereby perform adjustment of the optical axis direction thereof. Therefore, a member such as the lens 36 is not required.

The fifth embodiment of the lighting device according to the present embodiment will be described on the basis of FIGS. 9A and 9B. In the present embodiment, as with the first embodiment, a moth-proof lighting device is assumed as the lighting device.

In the present embodiment, there will be described a case where a second light emitting element which emits auxiliary light is provided compared to the lighting device 1A of the first embodiment.

In FIGS. 9A and 9B, for the purpose of explanation, an X axis is set in the direction of a central axis α of a lighting device 1E, and a Y axis and a Z axis are set in the direction perpendicular thereto in the same manner as in FIGS. 1A to 1C. FIG. 9A illustrates a cross-sectional view including the central axis α of the lighting device 1E in the present embodiment; and FIG. 9B illustrates a bottom view viewed from the lower direction of the central axis α of the lighting device 1E. However, in FIG. 9B, a light reflection member 59 as a first optical path conversion member and a window 58 are omitted. Although a description will be made assuming the direction of the central axis α as the direction of gravity in the same manner as in the first embodiment, the present invention is not limited thereto.

As illustrated in FIGS. 9A and 9B, the lighting device 1E is an LED bulb type lighting device that is provided with a plurality of first light emitting elements 51, and can apply main light to a first illumination region and auxiliary light to a second illumination region. The lighting device 1E is provided with a plug 3, an outer wall member 2, and a drive circuit 4. The configurations of the plug 3, the outer wall member 2, and the drive circuit 4 are the same as those of the first embodiment. Further, the setting of the first illumination region and the second illumination region is also the same as that of the first embodiment.

In order to apply main light to the first illumination region, in the present embodiment, eight first light emitting elements 51a to 51h, a printed circuit board 55 on which the first light emitting elements 51 are mounted, and a light blocking unit 52 are provided. The light blocking unit 52 is sealed by the window 58 which covers the bottom face of an internal space of the light blocking unit 52 to protect the first light emitting elements from rain or the like.

More specifically, as illustrated in FIG. 9B, the light blocking unit 52 includes a side light blocking unit 53 which is formed of the side face of a truncated cone and an upper light blocking unit 54 which is formed of the top face of the truncated cone. The side light blocking unit 53 has a function to block flashing light as main light emitted from the first light emitting elements 51 so as not to be directed to the direction perpendicular to the central axis α from the lighting device 1E.

In order to apply auxiliary light to the second illumination region, in the present embodiment, a single second light emitting element 56 which emits auxiliary light, a lens 57, and the light reflection member 59 as the first optical path conversion member which reflects a part of light emitted from the second light emitting element 56 toward the second illumination region are provided. The light blocking unit 52 is sealed by the window 58 which covers the bottom face of the internal space of the light blocking unit 52 to protect the first light emitting elements, the second light emitting element and the like from rain or the like. In the present embodiment, the window 58 is provided, and the light reflection member 59 is provided on the center of the window 58. However, the present invention is not limited thereto. The window 58 is not necessarily provided. The light reflection member 59 is only required to be provided outside the internal space, and may be provided in a place other than the window 58.

More specifically, the second light emitting element 56 is arranged on the center of the upper light blocking unit 54 with a printed circuit board 55 interposed therebetween, and is provided with the lens 57 which converts light emitted from the second light emitting element 56 into substantially parallel beams toward the light reflection member 59. Further, the window 58 of the present embodiment is formed of the side face and the bottom face of a cylinder. The light reflection member 59 is arranged on the center of the bottom face of the window 58 inside the internal space having a cylindrical shape surrounded by the window 58. The light reflection member 59 reflects light from the second light emitting element 56 so that the optical axis of the second light emitting element 56 is in the range of 85° to 90° with respect to the central axis α. The reflected light from the second light emitting element 56 is applied to the second illumination region through the window 58 which is composed of a transparent member.

Next, a light emitting operation of the first light emitting elements 51 will be described on the basis of FIG. 5. In the first light emitting elements 51, as illustrated in FIG. 5, from time T1 to time T2, the first light emitting element 51a and the first light emitting element 51e are in a light state. From time T2 to time T3, the first light emitting element 51b and the first light emitting element 51f are in a light state. From time T3 to time T4, the first light emitting element 51c and the first light emitting element 11g are in a light state. From time T4 to time T5, the first light emitting element 51d and the first light emitting element 51h are in a light state. With such a configuration, a partial illumination region looks like rotating in the clockwise direction on the first illumination region.

On the other hand, continuous light emitted from the second light emitting element 56 is reflected by the light reflection member 59 as the optical path conversion member, and thereby directed to the second illumination region in which an observer at a distant place is present. Therefore, a person at the second illumination region recognizes the lighting device 1E as a light source that is continuously lighted by auxiliary light from the second light emitting element 56, and hardly feels discomfort caused by flashing of main light from the first light emitting elements 51. In the present embodiment, any of the first light emitting elements 51a to 51h is lighted at every moment. Therefore, there is no all-dark period in which all of the first light emitting elements 51 are in a dark state. In addition to this, in the present embodiment, a person at the second illumination region can more reliably recognize the lighting device 1E as a continuous light source by virtue of auxiliary light from the second light emitting element 56.

The sixth embodiment of the lighting device according to the present embodiment will be described on the basis of FIGS. 9A and 9B. In the present embodiment, as with the first embodiment, a moth-proof lighting device is assumed as the lighting device.

In the sixth embodiment of the lighting device according to the present invention, one that is the same, in terms of hardware, as the lighting device 1E used in the fifth embodiment is used. However, an operation thereof is completely different from the lighting device 1E of the fifth embodiment. Light applying operations of the first lighting emitting elements 51 and the second light emitting element 56 will be described on the basis of FIGS. 10A and 10B which are graphs illustrating change with time of light emission.

In the present embodiment, the first light emitting elements 51a to 51h synchronously emit light in a period Tb in FIG. 10, and are synchronously in an off state in a period Td. This is an operation different from the operation in the fifth embodiment in which any of the first light emitting elements 51a to 51h always emits light at any time.

In the lighting device 1E, although main light emitted from the first light emitting elements 51a to 51h is blocked by the light blocking unit 52, light applied to the first illumination region from the first light emitting elements 51 may be indirectly applied to the second illumination region in rare cases. In such a case, flashing may be slightly perceived by a person at the second illumination region. Therefore, in the present embodiment, the second light emitting element 56 changes the emission intensity thereof so as to be low in the period Tb and high in the period Td so that the brightness of the entire light that is directly or indirectly applied to the second illumination region becomes substantially constant.

FIG. 10A illustrates a light emitting operation of the first light emitting elements 51. In the present embodiment, all of the first light emitting elements 51a to 51h perform a temporally synchronized light emitting operation. In FIG. 10A, Tb is a period during which the first light emitting elements 51 are in a light state, and Td indicates a period during which the first light emitting elements 51 are in a dark state. A flashing period is represented by Tb+Td. FIG. 10B illustrates a light emitting operation of the second light emitting element 56. A maximum value of the luminance of the second light emitting element viewed from a person at the second illumination region is higher by an offset than the luminance of the entire first light emitting elements 51 when all of the first light emitting elements 51 are in a light state at the same time. As illustrated in FIGS. 10A and 10B, in a period during which the first light emitting elements 51 are in a light state, the luminance of the second light emitting element 56 is set to the offset. In a period during which the first light emitting elements 51 are in a dark state, the luminance of the second light emitting element 56 is set to the maximum value. That is, the light emitting operation is performed so that the sum of the luminance of the entire first light emitting elements 51 and the luminance of the second light emitting element 56 viewed from a person at the second illumination region is always constant. In this specification, the case where the sum of the luminance of the entire first light emitting elements 51 and the luminance of the second light emitting element 56 viewed from a person is always constant has been described for the purpose of explanation. However, the sum is not necessarily exactly constant, and may vary within a range that can reduce a feeling of discomfort of a person caused by flashing.

With such a configuration, in the present embodiment, light having a constant luminance is applied to a person at the second illumination region by the entire of light that is indirectly applied from the first light emitting elements 51 and light that is directly applied from the second light emitting element 56. Therefore, substantially continuous light can be observed by the person.

In the sixth embodiment, flashing operations of the first light emitting elements 51a to 51h are synchronized. Therefore, there is an all-dark period during which all of the first light emitting elements 51 are in a dark state. Therefore, in order for the lighting device 1E to look like emitting continuous light by a person at a distant place, it is necessary that light from the second light emitting element 56 be applied to the second illumination region in which the person at a distant place is present.

The seventh embodiment of the lighting device according to the present embodiment will be described on the basis of FIGS. 11A and 11B. In the present embodiment, as with the first embodiment, a moth-proof lighting device is assumed as the lighting device.

While the lighting devices 1A to 1E of the first to sixth embodiments are LED bulb type lighting devices, there will be described, in the present embodiment, a case where a lighting device 1F is a straight tube type LED lighting device.

In FIGS. 11A and 11B, for the purpose of explanation, an X axis is set in the direction of a central axis α which passes through the center of the lighting device 1F in a cross section perpendicular to the longitudinal direction of the lighting device 1F, and a Y axis and a Z axis are set in the direction perpendicular thereto in the same manner as in FIGS. 1A to 1C. FIG. 11A illustrates a cross section including the X axis and the Y axis of the lighting device 1F in the present embodiment; and FIG. 11B illustrates a cross section including the X axis and the Y axis of the lighting device 1F in the present embodiment. Although a description will be made assuming the direction of the central axis α as the direction of gravity in the same manner as in the first embodiment, the present invention is not limited thereto.

As illustrated in FIGS. 11A and 11B, the lighting device 1F is a straight tube type LED lighting device that is provided with a plurality of first light emitting elements 61, and can apply light to a first illumination region and a second illumination region. The lighting device 1F is provided with a plug 3, a drive circuit 4, and a light scattering unit 67. The setting of the first illumination region and the second illumination region is the same as that of the first embodiment.

In order to apply main light to the first illumination region, in the present embodiment, forty-eight first light emitting elements 61L1 to 61L24 and 61R1 to 61R24, printed circuit boards 65 on which the first light emitting elements 61 are mounted, and a light blocking unit 62 are provided.

More specifically, as illustrated in FIGS. 11A and 11B, the light blocking unit 62 includes an upper light blocking unit 64 which is formed of one of side faces of a truncated square pyramid whose cross section is formed into a trapezoidal shape, in this example, a surface having contact with the upper bottom of the top face and a side light blocking unit 63 which is formed of four surfaces of the truncated square pyramid having contact with the upper light blocking unit 64. The inner side of the light blocking unit 62 is formed into a mirror surface or a white reflection surface. In order to reduce unnecessary reflected light and scattered light, a part or the entire of the inner side of the light blocking unit 62 may have a configuration that prevents the generation of reflected light and scattered light such as a black surface. In FIGS. 11A and 11B, for the purpose of explanation, the upper light blocking unit 64 is set so as to be perpendicular to the X axis, the lower bottoms of two top faces of the truncated square pyramid are set so as to be parallel to the Y axis, and the height direction of the truncated square pyramid is set so as to be parallel to the Z axis. The length in the Z axis direction (depth) of the outer wall member 2 is set to 60 cm.

In the present embodiment, the light blocking unit 62 also serves as the outer wall member 2. Further, the plug 3 is provided in one of the top faces, and the drive circuit 4 is provided on a central part of the upper light blocking unit 64. A cover is provided on the drive circuit 4 so that the drive circuit 4 cannot be directly visually recognized at the time of use. As with the first embodiment, the plug 3 is connected to a commercial AC power source (AC 100 V to 230 V, 50 Hz or 60 Hz), and supplies power to the drive circuit 4.

Each of the printed circuit boards 65 is a rectangular flat plate-like circuit board. As illustrated in FIG. 11A, the printed circuit boards 65 are arranged on two of the side faces of the truncated square pyramid, the two side faces constituting the side light blocking unit 63, inside an internal space surrounded by the light blocking unit 62 having a truncated square pyramid shape.

The first light emitting elements 61 are arranged on the printed circuit boards 65 in a matrix form. Specifically, as illustrated in FIGS. 11A and 11B, the first light emitting elements 61L 1 to 61L24 are aligned in a row along the Z direction on one of the two faces, and the first light emitting elements 61R1 to 61R24 are aligned in a row along the Z direction on the other face. Further, in the present embodiment, each of the first light emitting elements 61L1 to 61L24 and 61R1 to 61R24 is placed so that the optical axis direction of each of the first light emitting elements 61 is inclined with respect to the Z axis in consideration of unevenness in the intensity of applied light in the first illumination region.

As with the first embodiment, each of the first light emitting elements 61 is configured using a surface-mounted LED which has an excellent heat dissipation property and is suitable for illumination requiring high luminance, and emits light having a color coordinate of (0.42, 0.48) illustrated in FIG. 2.

In order to apply auxiliary light to the second illumination region, in the present embodiment, the light scattering member 67 as a first optical path conversion member which directs a part of light emitted from the first light emitting elements 61 toward the second illumination region is provided. The light scattering member 67 is arranged on the center of a window 66 which is composed of a generally rectangular flat plate transparent member which covers the bottom face of the internal space surrounded by the light blocking unit 62 outside the internal space having a truncated square pyramid shape surrounded by the light blocking unit 62. The light blocking unit 62 is sealed by the window 66 to protect the first light emitting elements from rain or the like. In the present embodiment, the light scattering member 67 is a member whose cross section including the X axis and the Y axis of the top face is convex curved surface. Further, as the first optical path conversion member, a light reflection member may be provided instead of the light scattering member 67. In the present embodiment, the window 66 is provided, and the light scattering member 67 is provided on the center of the window 66. However, the present invention is not limited thereto. The window 66 is not necessarily provided. The light scattering member 67 is only required to be provided outside the internal space surrounded by the light blocking unit 62, and may be provided in a place other than the window 66.

Next, a light applying operation in the lighting device 1F will be described on the basis of FIGS. 12A to 12C.

In the present embodiment, a first light-dark pattern and a second light-dark pattern are temporally alternately set by the flashing circuit 4a of the drive circuit 4. The first light-dark pattern is defined by the position of a first light emitting element 61 in a light state and the position of a first light emitting element 61 in a dark state in the plurality of first light emitting elements 61. The second light-dark pattern is a reverse pattern of the first light-dark pattern.

Specifically, for example, as illustrated in FIG. 12A, a pattern in which the first light emitting elements 61R1 to 61R24 are in a light state and the first light emitting elements 61L1 to 61L24 are in a dark state is conceivable as the first light-dark pattern.

As another light applying operation, as illustrated in FIG. 12B, it is conceivable that a pattern in which the first light emitting elements 61R1, 61R3, . . . , and 61R23 each having an odd index following R in the first light emitting elements 61R1 to 61R24 and the first light emitting elements 61L2, 61L4, . . . , and 61L24 each having an even index following L in the first light emitting elements 61L 1 to 61L24 are in a light state, and the other first light emitting elements 61 are in a dark state is used as the first light-dark pattern, and the reverse pattern thereof is used as the second light-dark pattern.

Further, as yet another light applying operation, as illustrated in FIG. 12C, it is conceivable that a pattern in which the first light emitting elements 61R1, 61R3, . . . , and 61R23 each having an odd index following R in the first light emitting elements 61R1 to 61R24 and the first light emitting elements 61L1, 61L3, . . . , and 61L23 each having an odd index following L in the first light emitting elements 61L1 to 61L24 are in a light state, and the other first light emitting elements 61 are in a dark state is used as the first light-dark pattern, and the reverse pattern thereof is used as the second light-dark pattern.

In the present embodiment, in a use state, whichever of the above light applying operations is used, either one of two first light emitting elements 61 in the same row (with the same index) is always in a light state. In other words, there is no all-dark period in which both of two first light emitting elements 61Rn and 61Ln (L=1 to 24) in the same row are in a dark state (a configuration with zero all-dark period). Therefore, the scattering member continuously emits auxiliary light, and a person at the second illumination region can perceive the auxiliary light as continuous light. The all-dark period is not necessarily zero, and when the all-dark period is set to be shorter than time that is perceivable by a human being, a person can perceive the light as continuous light. A normal person can perceive the light as continuous light when the all-dark period is 10 ms or less. Even a considerably sensitive person can perceive the light as continuous light when the all-dark period is 5 ms or less. Therefore, when switching a light-dark pattern, a time lag of 5 ms or less may be generated.

In the present embodiment, the case where the number of first light emitting elements 61 is forty-eight has been described. However, the present invention is not limited thereto. For example, when the first light emitting elements 61 are symmetrically arranged on two faces of a truncated square pyramid as in the present embodiment, it is only required to provide an even number of first light emitting elements 61. This case is preferred since any of the above light-dark patterns can be applied. Further, first light emitting elements 61 in a plurality of rows may be provided in a single side face. Further, an additional light blocking unit which is inclined in the Z direction may be formed instead of the truncated square pyramid, and the side face of the truncated square pyramid may be configured as the light blocking unit. In this case, the plug 3 is provided near the flashing circuit 4a and the drive circuit 4b at the side facing the upper light blocking unit.

The eighth embodiment of the lighting device according to the present embodiment will be described on the basis of FIGS. 16A and 16B. In the present embodiment, as with the first embodiment, a moth-proof lighting device is assumed as the lighting device.

In the present embodiment, there will be described a case where a single LED module is used as the first light emitting elements in the lighting device 1E of the sixth embodiment, and each of the first light emitting element and a second light emitting element emits light including blue light.

In FIGS. 16A and 16B, for the purpose of explanation, an X axis is set in the direction of a central axis α of a lighting device 1G, and a Y axis and a Z axis are set in the direction perpendicular thereto in the same manner as in FIGS. 1A to 1C. FIG. 16A illustrates a cross-sectional view including the central axis α of the lighting device 1G in the present embodiment; and FIG. 16B illustrates a bottom view viewed from the lower direction of the central axis α of the lighting device 1G. However, in FIG. 16B, a light distribution lens 77, a light scattering member 79 as a first optical path conversion member, and a window 78 are omitted. Although a description will be made assuming the direction of the central axis α as the direction of gravity in the same manner as in the first embodiment, the present invention is not limited thereto.

As illustrated in FIGS. 16A and 16B, the lighting device 1G is an LED bulb type lighting device that is provided with a first light emitting element 71 which is a single LED module, and can apply main light L1 to a first illumination region and auxiliary light L2 to a second illumination region. The lighting device 1G is provided with a plug 3, an outer wall member 2, and a drive circuit 4. In the first light emitting element 71, a plurality of semiconductor LED chips 71A are mounted on a single circuit board 71B. The semiconductor LED chips 71A can be simultaneously flashed in response to drive voltage applied from the outside. The configurations of the plug 3, the outer wall member 2, and the drive circuit 4 are the same as those of the first embodiment. Further, the setting of the first illumination region and the second illumination region is also the same as that of the first embodiment.

In order to apply main light L1 only to the first illumination region, in the present embodiment, the first light emitting element 71, the light distribution lens 77 for spreading light, and a light blocking unit 72 are provided. The light blocking unit 72 is sealed by a window 78 which is located slightly below a virtual internal space surrounded by the light blocking unit 72 to protect the first light emitting element 71 and a second light emitting element 76 from rain or the like.

More specifically, the light distribution lens 77 is axisymmetric with respect to the axis a, and has a light distribution lens recess 77A formed near the axis α. The light distribution lens 77 totally or partially reflects light that has been emitted from the first light emitting element 71 and reached the light distribution lens recess 77A. As illustrated in FIG. 16B, the light blocking unit 72 includes a side light blocking unit 73 which is formed of the side face of a truncated cone and an upper light blocking unit 74 which is formed of the top face of the truncated cone. The side light blocking unit 73 has a function to block flashing light as main light emitted from the first light emitting element 71 so as not to be directed to the direction perpendicular to the central axis α from the lighting device 1G. Each of the first light emitting element 71 and the second light emitting element 76 is a white LED, and has a spectrum obtained by synthesizing the spectrum of blue light emitted from the semiconductor LED chips and the spectrum of, for example, yellow light converted by the semiconductor LED chips. Since the window 78 is a filter that blocks blue light, the window 78 looks yellow. The window 78 cuts blue light from light emitted from the first light emitting element 71 and the second light emitting element 76.

In order to apply auxiliary light L2 to the second illumination region, in the present embodiment, the single second light emitting element 76 which emits auxiliary light L2 and the light scattering member 79 as the first optical path conversion member which scatters a part of light emitted from the second light emitting element 76 toward the second illumination region are provided. In the present embodiment, the window 78 is provided, and the light scattering member 79 is provided on the center of the window 78. However, the present invention is not limited thereto. The light scattering member 79 is only required to be provided outside the virtual internal space surrounded by the light blocking unit 72, and may be provided in a place other than the window 78.

More specifically, the second light emitting element 76 is arranged on the side light blocking unit 73 with a printed circuit board 75 interposed therebetween, and is provided with the lens 76A which converts light emitted from the second light emitting element 76 into substantially parallel beams toward the light scattering member 79. Further, the window 78 of the present embodiment is formed of the side face and the plain face having a cylindrical shape. The light scattering member 79 is arranged on the center of the plain face of the window 78. The light scattering member 79 scatters light from the second light emitting element 76. The scattered light from the second light emitting element 76 is applied as the auxiliary light L2 to the second illumination region through the window 78 which is composed of a yellow filter member.

In the present embodiment, the first light emitting element 71 is turned on and off in the same manner as the first light emitting elements 51 in the sixth embodiment. That is, the semiconductor LED chips 71A of the first light emitting element 71 synchronously emit light in a period Tb in FIG. 10, and are synchronously in an off state in a period Td.

In the lighting device 1G, although main light emitted from the first light emitting element 71 is blocked by the light blocking unit 72, light applied to the first illumination region from the first light emitting element 71 may be indirectly applied to the second illumination region in rare cases. In such a case, flashing may be slightly perceived by a person at the second illumination region. Therefore, in the present embodiment, the second light emitting element 76 changes the emission intensity thereof so as to be low in the period Tb and high in the period Td so that the brightness of the entire light that is directly or indirectly applied to the second illumination region becomes substantially constant.

As described above, in the present embodiment, FIG. 10A can be regarded as illustrating a light emitting operation of the first light emitting element 71 (in particular, the plurality of semiconductor LED chips 71A). In this case, in FIG. 10A, Tb is a period during which the first light emitting element 71 is in a light state, and Td is a period during which the first light emitting element 71 is in a dark state. A flashing period is represented by Tb+Td. Similarly, in the present embodiment, FIG. 10B can be regarded as illustrating a light emitting operation of the second light emitting element 76. A maximum value of the luminance of the second light emitting element viewed from a person at the second illumination region is higher by an offset than the luminance of the entire first light emitting element 71 when all of the semiconductor LED chips 71A are in a light state at the same time. As illustrated in FIGS. 10A and 10B, in a period during which the first light emitting element 71 is in a light state, the luminance of the second light emitting element 76 is set to the offset. In a period during which the first light emitting element 71 is in a dark state, the luminance of the second light emitting element 76 is set to the maximum value. That is, the light emitting operation is performed so that the sum of the luminance of the entire first light emitting element 71 and the luminance of the second light emitting element 76 viewed from a person at the second illumination region is always constant. In this specification, the case where the sum of the luminance of the entire first light emitting element 71 and the luminance of the second light emitting element 76 viewed from a person is always constant has been described for the purpose of explanation. However, the sum is not necessarily exactly constant, and may vary within a range that can reduce a feeling of discomfort of a person caused by flashing.

With such a configuration, in the present embodiment, light having a substantially constant luminance is applied to a person at the second illumination region by the entire of light that is indirectly applied from the first light emitting element 71 and light that is directly applied from the second light emitting element 76. Therefore, substantially continuous light can be observed by a person.

The ninth embodiment of the lighting device according to the present invention will be described on the basis of FIGS. 17A and 17B. Since the present embodiment is a modified example of the ninth embodiment, the same components as those of the ninth embodiment will be denoted by the same references.

FIG. 17A illustrates a cross-sectional view including a central axis α of a lighting device 1H in the present embodiment; and FIG. 17B illustrates a bottom view viewed from the lower direction of the central axis α of the lighting device 1H. However, in FIG. 17B, a light distribution lens 77 and a window 78 are omitted.

As illustrated in FIGS. 17A and 17B, the lighting device 1H is provided with three second light emitting elements 86 for emitting auxiliary light L2, and directly applies the auxiliary light L2 to a second illumination region from the second light emitting elements 86. Specifically, in the present embodiment, the auxiliary light L2 is applied to the second illumination region from the second light emitting elements 86 without converting the optical path of the auxiliary light L2 by using a first optical path conversion member or the like.

Further, as illustrated in FIG. 17A as a cross-sectional view, the lighting device 1H is an LED bulb type lighting device that is provided with a first light emitting element 71 which is a single LED module, and can apply main light L1 to a first illumination region and auxiliary light L2 to the second illumination region. The lighting device 1H is provided with a plug 3, an outer wall member 2, and a drive circuit 4.

In order to apply main light L1 only to the first illumination region, in the present embodiment, the first light emitting element 71, the light distribution lens 77 for spreading light, and a light blocking unit 72 are provided. The light blocking unit 72 is sealed by a window 78 which is located slightly below a virtual internal space surrounded by the light blocking unit 72 and covers the internal space to protect the first light emitting element 71 and the second light emitting elements 86 from rain or the like.

Each of the first light emitting element 71 and the second light emitting elements 86 is a commercially available white LED, and has a spectrum obtained by synthesizing the spectrum of blue light emitted from the semiconductor LED chips and the spectrum of, for example, yellow light converted by semiconductor LED chips. Since the window 78 is a filter that blocks blue light, the window 78 looks yellow. The window 78 cuts blue light from light emitted from the first light emitting element 71 and the second light emitting elements 76.

As illustrated in FIG. 17A, in the present embodiment, in order to directly apply auxiliary light L2 to the second illumination region, the three second light emitting elements 86, second light emitting element lenses 86A which direct light from the respective second light emitting elements 86 toward the second illumination region, and circuit boards 85 which support the respective second light emitting elements are provided. Instead of providing the circuit boards 85, each of the second light emitting elements 86 may be of a type that is provided with a lead frame, and is supported by appropriately bending the lead frame. The number of second light emitting elements 86 is not limited to three, and preferably two or more and eight or less. In the present embodiment, a first optical path conversion member is not required for directly applying auxiliary light L2 to the second illumination region.

Since operations of the first light emitting element 71 and the second light emitting elements 86 in the present embodiment are the same as those described in the eighth embodiment, a description thereof will be omitted.

In the present embodiment, a second phosphor that is excited by light emitted from a first light emitting element is used as a second light emitting element. The “light emitting element” indicates an element (component) having a light emitting function, and is therefore not limited to one that emits light by being excited by supply of power such as a light emitting diode. The “light emitting element”, of course, includes a phosphor which emits light by being excited by light emitted from the outside.

A lighting device 1J according to the tenth embodiment is illustrated in FIGS. 18A and 18B. In FIGS. 18A and 18B, an X axis is set in the direction of a central axis α of the lighting device 1J, and a Y axis and a Z axis are set in the direction perpendicular thereto. FIG. 18A illustrates a cross-sectional view including the central axis α of the lighting device 1J in the present embodiment; and FIG. 18B illustrates a bottom view viewed from the lower direction of the central axis α of the lighting device 1J. However, in FIG. 18B, a window 98 is omitted. Although a description will be made assuming the direction of the central axis α as the direction of gravity in the same manner as in the first embodiment, the present invention is not limited thereto.

As illustrated in FIG. 18A, the lighting device 1J is an LED bulb type lighting device that is provided with a plurality of first light emitting elements 91, and can apply main light L1 to a first illumination region. The lighting device 1J is provided with a plug 3, an outer wall member 2, and a drive circuit 4. The configurations of the plug 3, the outer wall member 2, and the drive circuit 4 are the same as those of the first embodiment. Each of the first light emitting elements 91 is a white LED, and has a spectrum obtained by synthesizing the spectrum of blue light emitted from a semiconductor LED chip and the spectrum of, for example, yellow light converted by the semiconductor LED chip. A second light emitting element (second phosphor) 96 is excited by light emission of the first light emitting elements 91, and thereby emits light. Since the window 98 is a filter that blocks blue light, the window 98 looks yellow. The window 98 cuts blue light from light emitted from the first light emitting elements 91 and the second light emitting element (second phosphor) 96.

In order to apply main light to the first illumination region, in the present embodiment, eight first light emitting elements 91a to 91h, a printed circuit board 55 on which the first light emitting elements 91 are mounted, and a light blocking unit 52 are provided. The light blocking unit 52 is sealed by the window 98 which covers the bottom face of an internal space of the light blocking unit 52 to protect the first light emitting elements from rain or the like.

In order to apply auxiliary light L2 to the second illumination region, in the present embodiment, the second light emitting element (second phosphor) 96 which includes a phosphor that emits light by receiving, in particular, blue light that is emitted from the first light emitting elements 51 is arranged on the inner side of the window 98 (the side near the first light emitting elements). The second light emitting element (second phosphor) 96 is excited by blue light. A material that includes a phosphor of relatively long afterglow which emits visible light having a longer wavelength than blue light is used as the second light emitting element (the second phosphor) 96. Specifically, a phosphor having two kinds of activator elements, in particular, Gd₃Sc₂₋ₓGa₃₊ₓO₁₂:Ce³⁺, Hf³⁺ which is a garnet-based phosphor is preferably used. Further, in addition to a garnet phosphor, an aluminate phosphor (SrAl₂O₄: Eu, Dy, and Ca_{0.42}Sr_{1.5}Al₂SiO₇: Ce³⁺, Tb³⁺, for example), a silicate phosphor (Ba₂MgSi₂O₇: Eu²⁺, Mn²⁺, for example) and the like also have excellent light emitting efficiency and excellent weatherability, and can therefore be preferably used. The decay time constant of the above phosphor is approximately several hours. Even when a dark period of the first light emitting elements is 1000 ms and therefore long, such a long afterglow phosphor continuously emits light for the entire dark period. Therefore, the phosphor actually continuously emits auxiliary light L2 as a continuous light source. As a relatively long afterglow phosphor, a phosphor having a decay time constant that is three times or more of the dark period is preferred. For example, a phosphor having a decay time constant of approximately 240 ms or more when the dark period is 80 ms is preferred.

The second light emitting element emits light by being excited by light from the first light emitting elements, and also emits light by being excited by the sunlight. Therefore, when a phosphor having a long decay time, for example, one hour or more is used, it is preferred to arrange the phosphor at a position to which the sunlight is sufficiently applied. Since the sunlight contains ultraviolet rays, an ultraviolet ray excitable long afterglow phosphor, for example, SrAl₂θ₄: Eu, Dy is preferably used. When ultraviolet rays of the sunlight are used as an excitation light source, a phosphor as the second light emitting element is preferably arranged outside the window which is composed of a filter material.

In the present embodiment, the first light emitting elements 91 are turned on and off in the same manner as the first light emitting elements 11 in the first embodiment. Therefore, a light emitting operation of the first light emitting elements in the present embodiment will be described on the basis of FIG. 5. In the first light emitting elements 91, as illustrate in FIG. 5, from time T1 to time T2, the first light emitting element 91a and the first light emitting element 91e are in a light state. From time T2 to time T3, the first light emitting element 91b and the first light emitting element 91f are in a light state. From time T3 to time T4, the first light emitting element 91c and the first light emitting element 11g are in a light state. From time T4 to time T5, the first light emitting element 91d and the first light emitting element 91h are in a light state. With such a configuration, a partial illumination region looks like rotating in the clockwise direction on the first illumination region.

<1> In the first to sixth, and tenth embodiments, there has been described the case where eight first light emitting elements are provided. However, the present invention is not limited thereto. In order to perform pseudo-rotation, it is preferred to provide first light emitting elements the number of which is an integral multiple of the number of first light emitting elements that become a light state at the same time. FIG. 13 illustrates a case where twelve first light emitting elements 31 are provided.

<2> In the first to sixth, and tenth embodiments, there has been described the case where the light-dark pattern in which a pair of first light emitting elements that are located opposite to each other across the central axis α are in a light state and the other first light emitting elements are in a dark state is rotated by a single first light emitting element at each time Tb. However, the present invention is not limited thereto.

FIGS. 14A to 14E illustrate an example of change with time of a light-dark pattern. For the purpose of explanation, there is described a case where the lighting device 1 is provided with twelve first light emitting elements which are arranged as illustrated in FIG. 13.

FIG. 14A illustrates, when twelve first light emitting elements are provided, change with time of a light-dark pattern in which a pair of first light emitting elements that are located opposite to each other across the central axis α are in a light state and the other first light emitting elements are in a dark state when the light-dark pattern is rotated by a single first light emitting element at each time. Further, the light-dark pattern may be rotated by m first light emitting elements (m is an integer equal to or more than two and equal to or less than six when the number of first light emitting elements is twelve) at each time.

FIG. 14B illustrates, when twelve first light emitting elements are provided, change with time of a light-dark pattern in which three first light emitting elements that are located at every four first light emitting elements are in a light state and the other first light emitting elements are in a dark state when the light-dark pattern is rotated by a single first light emitting element at each time. Further, the light-dark pattern may be rotated by m first light emitting elements (m is an integer equal to or more than two and equal to or less than six when the number of first light emitting elements is twelve) at each time. With such a configuration, three first light emitting elements that are located on the apexes of an equilateral triangle are always in a light state. Therefore, it is possible to further reduce unevenness in the intensity of light in the scattering member.

FIG. 14C illustrates, when twelve first light emitting elements are provided, change with time of a light-dark pattern in which four first light emitting elements that are located at every three first light emitting elements are in a light state and the other first light emitting elements are in a dark state when the light-dark pattern is rotated by a single first light emitting element at each time. Further, the light-dark pattern may be rotated by m first light emitting elements (m is an integer equal to or more than two and equal to or less than six when the number of first light emitting elements is twelve) at each time.

FIG. 14D illustrates, when twelve first light emitting elements are provided, change with time a light-dark pattern in which adjacent two first light emitting elements are considered as one group, and first light emitting elements belonging to a pair of groups that are located opposite to each other across the central axis α are in a light state and the other first light emitting elements are in a dark state when the light-dark pattern is rotated by two first light emitting elements at each time.

FIG. 14E illustrates change with time of the light-dark pattern illustrated in FIG. 14D when the light-dark pattern is rotated by a single first light emitting element at each time.

Further, although not illustrated, change with time of a light-dark pattern in which a first light emitting element to be a light state is randomly set while continuously setting at least any one of the first light emitting elements to a light state may be employed.

<3> In the first, second and fourth embodiments, there has been described the case where, in the LED bulb type lighting device 1, the window is composed of a flat plate-like transparent member and provided with the light scattering member. However, the present invention is not limited thereto. For example, as illustrated in FIG. 15A, a light reflection member may be provided on the center of a window the central part of which is curved outward inside an internal space of a light blocking unit. Alternatively, as illustrated in FIG. 15B, a light reflection member may be provided on the center of a flat plate window in an external space of a light blocking unit.

<4> In the first to tenth embodiments, the description has been made assuming the case where a LED is used as the first light emitting element. However, the present embodiment is not limited thereto, and a sodium lamp or the like may also be used.

<5> In the first to tenth embodiments, there has been described the case where the first light emitting element itself flashes. However, for example, the first light emitting element may be provided with a mirror which reflects light, and the mirror may be rotated to perform application of rotating light. In this case, even when the first light emitting element is not suitable for a flashing operation, it is possible to obtain an effect of a flashing operation while continuously lighting the first light emitting element. As a result, deterioration of the first light emitting element can be reduced.

<6> In the first to tenth embodiments, there has been described the case where main light applied to the first illumination region is flashing light. However, for example, main light that is applied to the first illumination region by the first light emitting element may be continuous light having a color temperature of 4000 K to 6500 K, and auxiliary light that is applied to the second illumination region by the second light emitting element may be continuous light of 2000 K to 3500 K with less light scattering.

Further, for example, main light that is applied to the first illumination region by the first light emitting element may be red continuous light, and auxiliary light that is applied to the second illumination region by the second light emitting element may be bulb-colored continuous light of 2000 K to 3500 K or white continuous light of 3500 K to 6500 K. Red light can be used to inhibit flowering of chrysanthemum or the like. However, if red light leaks to the surrounding area, the entire surrounding area becomes red, which may disadvantageously give a feeling of discomfort to the neighboring residents. Therefore, by directing white or bulb-colored auxiliary light to the surrounding area, it is possible to reduce the influence on the surrounding area. That is, it is possible to reduce the influence on the surrounding area caused by main light by using auxiliary light that has a different quality (color, wavelength, color temperature and the like), namely, a different spectrum from that of the main light.

When the lighting device has such a configuration, for example, the lighting device can also be used as a light source for flowering adjustment of agricultural short-day plants or a general street light.

### EXPLANATION OF REFERENCES

1 lighting device
1A lighting device
1B lighting device
1C lighting device
1D lighting device
1E lighting device
1F lighting device
1G lighting device
1H lighting device
1J lighting device
2 outer wall member
3 plug
4 drive circuit
4a flashing circuit
4b power circuit
11 first light emitting element
12 light blocking unit
13 side light blocking unit
14 upper light blocking unit
15 printed circuit board
16 window
17 light scattering member (first optical path conversion member)
21 first light emitting element
22 light blocking unit
23 side light blocking unit
24 upper light blocking unit
25 printed circuit board
26 prism (second optical path conversion member)
31 first light emitting element
32 light blocking unit
33 side light blocking unit
34 upper light blocking unit
35 printed circuit board
36 lens
37 window
38 light scattering member (first optical path conversion member)
41 first light emitting element
42 light blocking unit
43 side light blocking unit
44 upper light blocking unit
45 printed circuit board
51 first light emitting element
52 light blocking unit
53 side light blocking unit
54 upper light blocking unit
55 printed circuit board
56 second light emitting element
57 lens
58 window
59 light reflection member (first optical path conversion member)
61 first light emitting element
61R first light emitting element
61L first light emitting element
62 light blocking unit
63 side light blocking unit
64 upper light blocking unit
65 printed circuit board
66 window
67 light scattering member (first optical path conversion member)
71 first light emitting element
71A LED chip
71B circuit board
72 light blocking unit
73 side light blocking unit
74 upper light blocking unit
75 circuit board
76 second light emitting element
76A second light emitting element lens
77 light distribution lens
77A light distribution lens recess
78 window
79 light scattering member (first optical path conversion member)
85 circuit board
86 second light emitting element
86A second light emitting element lens
87 lens
88 window
L1 main light
L2 auxiliary light
AS partial illumination region
H person

1. A lighting device comprising:
at least one first light emitting element;
a light blocking unit; and
a first light path conversion member, the lighting device being capable of applying light to a first illumination region and a second illumination region different from the first illumination region, wherein
the first light emitting element is capable of emitting flashing light illuminating the first illumination region,
the light blocking unit blocks light that is emitted from the first light emitting element and directed to a region other than the first illumination region, and
the first light path conversion member converts an optical path of light emitted from the first light emitting element so that the second illumination region is illuminated with light that is perceived to have a smaller light-dark intensity difference than flashing light from the first light emitting element using light emitted from the first light emitting element.

2. A lighting device comprising:
at least one first light emitting element;
at least one second light emitting element; and
a light blocking unit, the lighting device being capable of applying light to a first illumination region and a second illumination region different from the first illumination region, wherein
the first light emitting element is capable of emitting flashing light that reaches the first illumination region,
the light blocking unit blocks light that is emitted from the first light emitting element and directed to a region other than the first illumination region, and
the second illumination region is illuminated with light that is perceived to have a smaller light-dark intensity difference than flashing light from the first light emitting element using at least a part of light emitted from the second light emitting element.

3. The lighting device according to claim 1, wherein light illuminating the second illumination region is light that is perceived as continuous light by a person at the second illumination region.

4. The lighting device according to claim 1, wherein the first optical path conversion member is provided outside an internal space surrounded by the light blocking unit.

5. The lighting device according to claim 1, comprising a plurality of first light emitting elements, wherein each of all-dark periods in which all of the first light emitting elements are in a dark state is set shorter than time perceivable by a human being.

6. (canceled)

7. The lighting device according to claim 1, wherein the light blocking unit includes a side light blocking unit blocking light that is directed to the second illumination region from the first light emitting element without conversion of the optical path thereof, and an upper light blocking unit covering the upper part of the side light blocking unit.

8. The lighting device according to claim 1, wherein the first light emitting element comprises a plurality of first light emitting elements, and a first light-dark pattern defined by the position of a first light emitting element in a light state and the position of a first light emitting element in a dark state and a second light-dark pattern which is a reverse pattern of the first light-dark pattern are temporally alternately set.

9. The lighting device according to claim 2, wherein the second light emitting element emits continuous light.

10-11. (canceled)

12. The lighting device according to claim 2, wherein the second light emitting element emits light so that the intensity of the entire light that is directly or indirectly applied to the second illumination region falls within a predetermined light intensity range when viewed from a person at the second illumination region depending on the emission intensity of the first light emitting element viewed from a person at the second illumination region.

13. The lighting device according to claim 1, further comprising a second optical path conversion member bending an optical axis of the first light emitting element toward the first illumination region.

14. The lighting device according to claim 1, further comprising a central axis, wherein
the first illumination region includes a region below the central axis, and
the second illumination region includes a direction perpendicular to the central axis of the lighting device.

15-18. (canceled)

19. A lighting device comprising:
at least one first light emitting element;
at least one second light emitting element; and
a light blocking unit, the lighting device being capable of applying light to a first illumination region and a second illumination region different from the first illumination region, wherein
the first light emitting element is capable of emitting main light illuminating the first illumination region,
the second light emitting element is capable of emitting auxiliary light having a spectrum different from the spectrum of the main light, the auxiliary light illuminating the second illumination region,
the light blocking unit blocks light that is emitted from the first light emitting element and directed to a region other than the first illumination region,
light emitted from the second light emitting element is applied to the second illumination region, and
the second illumination region includes a direction perpendicular to an axis of the lighting device.

20. The lighting device according to claim 2, wherein light illuminating the second illumination region is light that is perceived as continuous light by a person at the second illumination region.

21. The lighting device according to claim 2, further comprising a first optical path conversion member converting the optical path of light entering the first optical path conversion member so as to illuminate the second illumination region, wherein the first optical path conversion member is provided outside an internal space surrounded by the light blocking unit.

22. The lighting device according to claim 2, comprising a plurality of first light emitting elements, wherein each of all-dark periods in which all of the first light emitting elements are in a dark state is set shorter than time perceivable by a human being.

23. The lighting device according to claim 2, wherein the light blocking unit includes a side light blocking unit blocking light that is directed to the second illumination region from the first light emitting element without conversion of the optical path thereof, and an upper light blocking unit covering the upper part of the side light blocking unit.

24. The lighting device according to claim 2, wherein the first light emitting element comprises a plurality of first light emitting elements, and a first light-dark pattern defined by the position of a first light emitting element in a light state and the position of a first light emitting element in a dark state and a second light-dark pattern which is a reverse pattern of the first light-dark pattern are temporally alternately set.

25. The lighting device according to claim 2, further comprising a second optical path conversion member bending an optical axis of the first light emitting element toward the first illumination region.

26. The lighting device according to claim 2, further comprising a central axis, wherein
the first illumination region includes a region below the central axis, and
the second illumination region includes a direction perpendicular to the central axis of the lighting device.

27. The lighting device according to claim 2, wherein the first light emitting element emits yellow component light having a peak wavelength of 540 nm or more and 620 nm or less, and does not emit blue component light having a wavelength of 400 to 500 nm or emits light having an intensity that does not allow blue component light having a wavelength of 400 to 500 nm to have an insect attracting action.
